(19) United States
(12) Patent Application Publication
(10) Pub. No.: US 2008/0172545 A1
(43) Pub. Date: Jul. 17, 2008

(54) SYSTEM AND METHOD FOR ACCESSING AND DISPLAYING INTERACTIVE CONTENT AND ADVERTISING

(76) Inventor: John Christian Boucard, Pasadena, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/836,072

(22) Filed: Aug. 8, 2007

Related U.S. Application Data
(60) Provisional application No. 60/884,845, filed on Jan. 12, 2007.

(51) Int. Cl. G06F 12/02

(52) U.S. Cl. 711/221; 711/E12.014

(57) ABSTRACT

System and method for accessing and displaying personal information along with advertisement, software applications, or the like. The system and method include: retrieving from a memory device a unique identifier and a pointer; retrieving a redirect pointer from a pointer table responsive to the retrieved unique identifier and pointer; executing the retrieved redirect pointer to launch a software application to display a first content; displaying a second content and/or an advertisement with the first content.

### CROSS-REFERENCE TO RELATED APPLICATIONS

This Patent Application claims the benefit of the filing date of U.S. Provisional Patent Application Ser. No. 60/884,845, filed on Jan. 12, 2007 and entitled “SYSTEM AND METHOD FOR ACCESSING PERSONAL ON-LINE INFORMATION WITH ADVERTISEMENT,” the entire content of which is hereby expressly incorporated by reference.

### FIELD OF THE INVENTION

The present invention relates generally to accessing specific data, and more specifically to system and method for accessing personal on-line information with advertisement.

### BACKGROUND OF THE INVENTION

Multimedia and other data content are typically distributed on storage mediums such as a USB Stick, CD, VCD or DVD, and have traditionally been viewed and listened to on a television set, monitor, personal computer, or the like. The Internet has added the ability to locate content by a uniform resource locator (URL). Usually, data, audio and video content stored on specific media are organized by hierarchical menus and can be accessed selectively. Content in World Wide Web (WWW), however, is often stored in more than one location and one type of storage media. Therefore, in order to present a complete user experience, related content must first be identified and then selectively accessed using an appropriate media player or storage device before the user is presented with the content.

Advertising on the Internet is a source of revenue for an increasing number of websites and companies. The use of rich media and static images is particularly popular in Internet advertising (online advertisements). Rich media ads are becoming increasingly popular generally using Macromedia Flash™. Rich media advertising utilizes color, imagery, page layout, and other elements to attract the reader's attention. Some examples of rich media ads include “banner ads.” A banner ad is typically a standard image displayed on a website. Banner ads come in numerous sizes, but are often rectangular. In addition, ads containing streaming video or streaming audio are becoming popular with advertisers.

An ad server is typically a computer server that stores advertisements and delivers (serves) them to website visitors. Ad servers typically include local ad servers and third-party or remote ad servers. Local ad servers are typically run by a single publisher and serve ads to that publisher's domains, allowing customization, creative formatting, and content control by a specific publisher. Remote ad servers typically serve ads across domains owned by several publishers. Remote ad servers send the ads from one central source so that advertisers and publishers can track the distribution of their online advertisements, and have centralized location for controlling the rotation and distribution of their advertisements across the web.

Furthermore, affiliate marketing on Internet is a form of advertising on Internet where the advertiser allows a potentially large number of small publishers to pick specific creative elements or offers to market in exchange for payment should such marketing create sales or other revenue.

### SUMMARY

In some embodiments, the present invention is a system and method for accessing and displaying information. The system and method includes: retrieving from a memory device a unique identifier and a pointer; retrieving a redirect pointer from a pointer table responsive to the retrieved unique identifier and pointer; executing the retrieved redirect pointer to launch a software application to display content; selecting an advertisement from an ad database responsive to the retrieved unique identifier; and displaying the selected advertisement with the content.

In some embodiments, the present invention is a system and method for accessing and displaying information. The system and method include: retrieving from a memory device a unique identifier and a pointer; retrieving a redirect pointer from a pointer table responsive to the retrieved unique identifier and pointer; executing the retrieved redirect pointer to launch a software application to display a first content; and displaying a second content with the first content responsive to the retrieved unique identifier.

In some embodiments, the memory device may be coupled to a PC, PDA, cell phone, iPOD™, game console, Pocket PC, and the like. Moreover, the memory device may have, or may be embedded in an object having a themed appearance with relevance to the content pointed by the memory device. The memory device may include one or more switches for selecting one or more unique identifiers and/or selecting one or more unique pointers.

In some embodiments, the memory device may be chained (or connected) to a second memory device for exporting the unique identifier(s) to the second memory device.

In some embodiments, the software application may launch a second application, a game, a website, a song, and the like.

### BRIEF DESCRIPTION OF THE DRAWINGS

FIG. 1 is an exemplary block diagram of a system operative in accordance with one embodiment of the invention;

FIG. 2 is a schematic representation of an exemplary memory device including one or more identifiers and one or more pointers, according to an embodiment of the present invention;

FIG. 3 is an exemplary flow diagram, according to an embodiment of the present invention;

FIG. 4 is an exemplary block diagram depicting the creating of a pointer to be embedded in a memory device, according to one embodiment of the present invention;

FIG. 5 illustrates an exemplary process flow for creating a user in a server according to one embodiment of the present invention;

FIGS. 6A and 6B depict two simplified hand handshake protocols between a memory device and a computer to modify or launch content, according to some embodiments of the present invention;

FIG. 7 is an exemplary process flow diagram showing a server basic process for receiving and executing a pointer, according to one embodiment of the present invention;

FIG. 8 is an exemplary block diagram depicting the retrieval of a content pointed to by a pointer embedded in a memory device, according to one embodiment of the present invention;

FIG. 9 is a more detailed exemplary process for selecting a pointer source, according to one embodiment of the present invention;

FIG. 10 is a more detailed exemplary process for applying pointer source permissions, according to one embodiment of the present invention;

FIGS. 11A, 11B, and 11C are exemplary process flows for executing the pointer payload processor, according to one embodiment of the present invention;

FIGS. 12A-12I show exemplary data table for batches, Group Permission, Overrides, Pointers, Users, User Groups, Groups, Processors, and Processor Properties, according to one embodiment of the present invention;

FIG. 13 is a more detailed exemplary process for executing a pointer payload process, according to one embodiment of the present invention;

FIG. 14 shows an exemplary process for selecting an ad banner, according to one embodiment of the present invention;

FIGS. 15A and 15B show exemplary batch processing; and

FIGS. 16A and 16B show exemplary batch processing with overrides.

### DETAILED DESCRIPTION

In one embodiment, the system of the present invention includes a themed memory device which inserts into a port (for example, a USB port) of a computing device, for example a PC, pocket PC, cell phone, iPOD™, a game console, and the like. The memory device is themed (or placed in a themed object) and economically designed in a wide variety of interesting shapes or representations, such as, a heart, a phone, a character, an animal, a toy, a greeting card (or a component thereof), a wearable item, such as a bracelet, necklace, or ring, a soft drink bottle, soccer ball or a flag. The memory device is designed to be used many times and passed around between friends or business associates.

In one embodiment, the themed memory device includes a memory chip with associated drivers, one or more unique identifiers (UIDs), and one or more pointers embedded on the chip with software. The one and/or more UIDs and pointers may invoke one or more specific websites, and/or launch one or more specific applications.

In one embodiment, the themed memory device is associated with a website (for example, myclickable.com™), which allows a user (device holder) to download widgets or similar interface applications that increase the functionality of the device. A widget (or control) is typically a user interface that a user interacts with, such as a window or a text box.

When inserted into the port, the themed memory device automatically points the user's web browser to a pre-designated website (a publisher's website). In one embodiment, the pre-designated website serves an ad, such as a banner ad that is displayed with the content that the pointer embedded in the memory device is pointing to. In one embodiment, the ad is displayed with a framed webpage displaying the content. The ad can be modified by the user or served by a sponsor relationship.

In some embodiments, a software application or a second content maybe displayed instead of, or in addition to the ad. In one embodiment, the ad or the content impressions and clicks are stored and made available to determine additional user demographic information which may be tracked and reported.

In one embodiment, a desktop application reads one or more unique identifiers (UIDs) and one or more pointers from a memory device. Based on the UID(s) and/or pointer(s), the desktop application retrieves a redirect pointer from a pointer database (table). The desktop application then executes the redirect pointer to launch a software application. The desktop application then displays the results of the launched software application along with an advertisement selected from a number of different advertisements. The ads include predetermined content and may be displayed randomly, or based on different criteria.

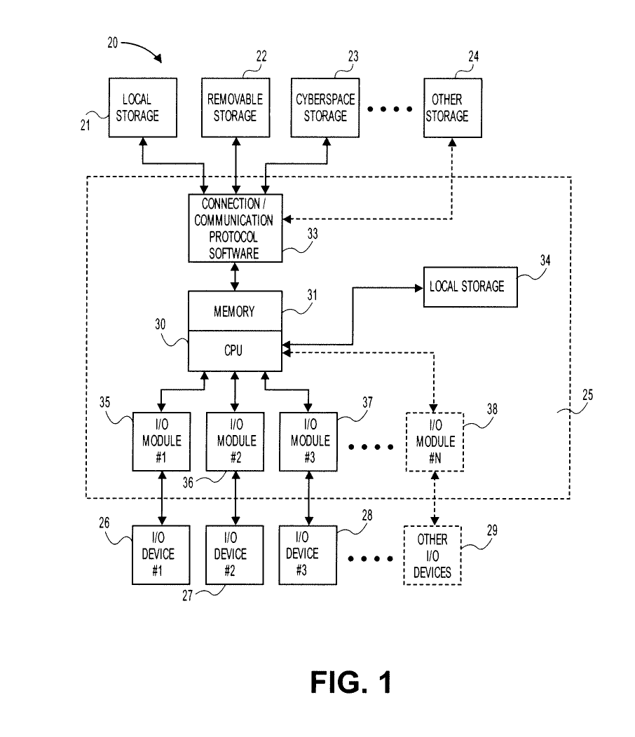

FIG. 1 is a block diagram of a system 20 operative in accordance with one embodiment of the invention. The system includes a processor 25 represented by a dotted line. The processor, illustratively, comprises a computer with a CPU 30 and memory 31 with various 1/0 modules 35, 36, 37 . . . 38 and connection/communication protocol software 33 with local storage 34 which could reside in memory 31.

Various storage mediums 21, 22, 23 - - - 24 representing local PC storage medium, removable storage medium, cyberspace storage medium and other storage medium respectively, are operative under the control of the connection/communication protocol software. Similarly, various 1/O devices 26, 27, 28 . . . 29 are connected to 1/O modules 35, 36, 37 . . . 38 respectively.

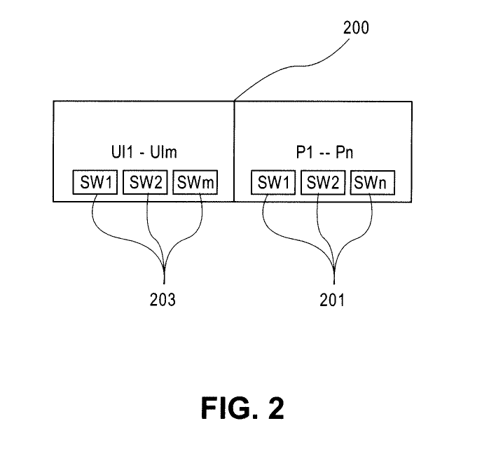

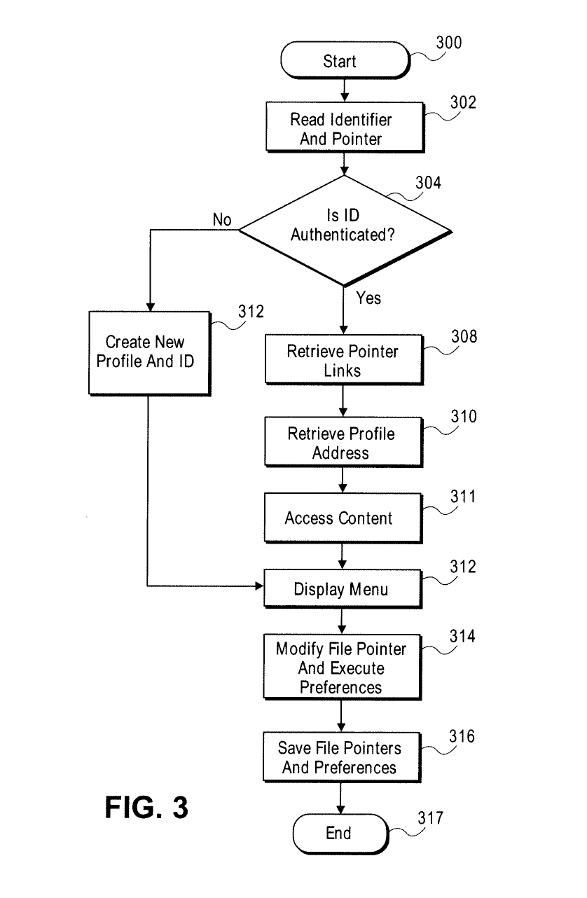

FIG. 2 is a schematic representation of a memory device 200 with one or more identifiers UI1, . . . UIm and a plurality of pointers P1, . . . Pn. The memory device includes one or more switches indicated at 201 and 203. Switch(es) 201 are user operative to select a particular pointer and Switch(es) 203 are user operative to select a particular identifier. Thus, in the embodiment of FIG. 2, the user is able to selectively choose one or more identifiers and one or more pointers. The memory device 200 of FIG. 2 may be used for accessing a system, for example, the system of FIG. 1. The memory device is read by a reader, such as the 1/O device 26 in FIG. 1 and software 33 of FIG. 1, and responds as described in connection with the flow diagram of FIG. 3.

The software is invoked when a memory device is read by a reader or a software application, as indicated at 300 in FIG. 3. The identifier (UID or UI) in the memory device is read as indicated at 302. If the identifier UID (UI and UID are used interchangeably in this document and mean the same) is already stored in the system, it is authenticated in 304. The pointer (P) in the memory device is then allowed to link to (retrieve) the profile address at which the locations of files related to the identifier are stored, in block 308. In block 310, the profile address is retrieved from a remote database, or locally. The files/content addressed by the profile are then accessed and executed as indicated at 311.

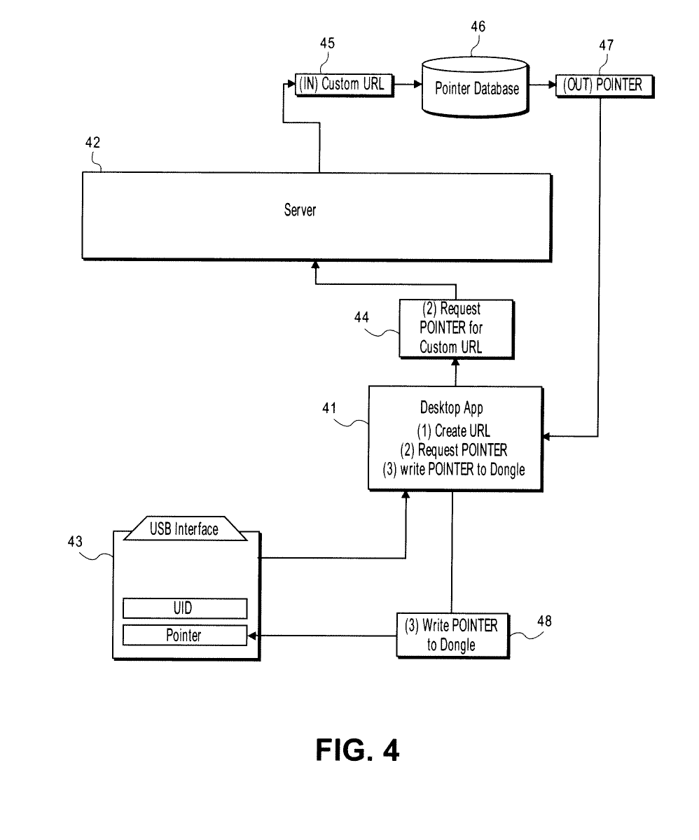

In one embodiment, the system and method of the present invention creates one or more pointers embedded in the device. FIG. 4 is an exemplary block diagram depicting the creating of a pointer to be embedded in the themed memory device, that is programming the memory device according to one embodiment of the present invention. The pointer creation process includes a desktop application 41 with Internet access, a server 42, and a connected device 43. Although a USB memory device (dongle) has been used as an example for the themed memory device to demonstrate the functionality of the present invention, as one with ordinary skill in the art of computer memory would easily realize, the memory device is not limited to a USB dongle and may include different types of pluggable memory devices.

An exemplary process for creating and embedding one or more pointers in the memory device is now described. First, a valid custom URL 44, for example, a simple webpage link is manually entered by the user, or a URL previously returned by the server and unseen by the user is acquired. Then, the desktop application requests a pointer from the server, passing the custom URL as one of the parameters 44. The server then adds the custom URL 45 to a Pointer Database 46 and returns to the desktop application 41 a pointer 47 to the custom URL. In one embodiment, the returned pointer includes additional embedded tags which can modify the presentation of retrieved data pointed to by the pointer. The pointer returned to the client application is then stored 48 in the connected (USB) themed device 43. The same pointer may also be written into any number of themed memory devices.

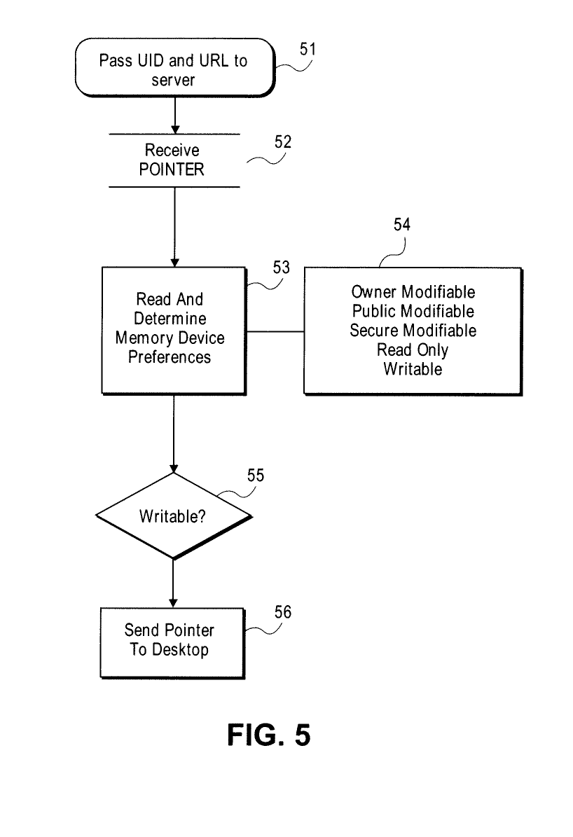

FIG. 5 illustrates an exemplary process flow for creating a user in the server according to one embodiment of the present invention. The memory device is connected to a reader and the UID and pointer are passed to the server 51. The server receives the pointer (52) and then reads the pointer and determines if there are any preferences (53), such as owner modifiable, public modifiable, secure modifiable, read only, or writable (54). If the pointer is writable (55), the pointer is sent to the desktop application and the pointer field is written (56).

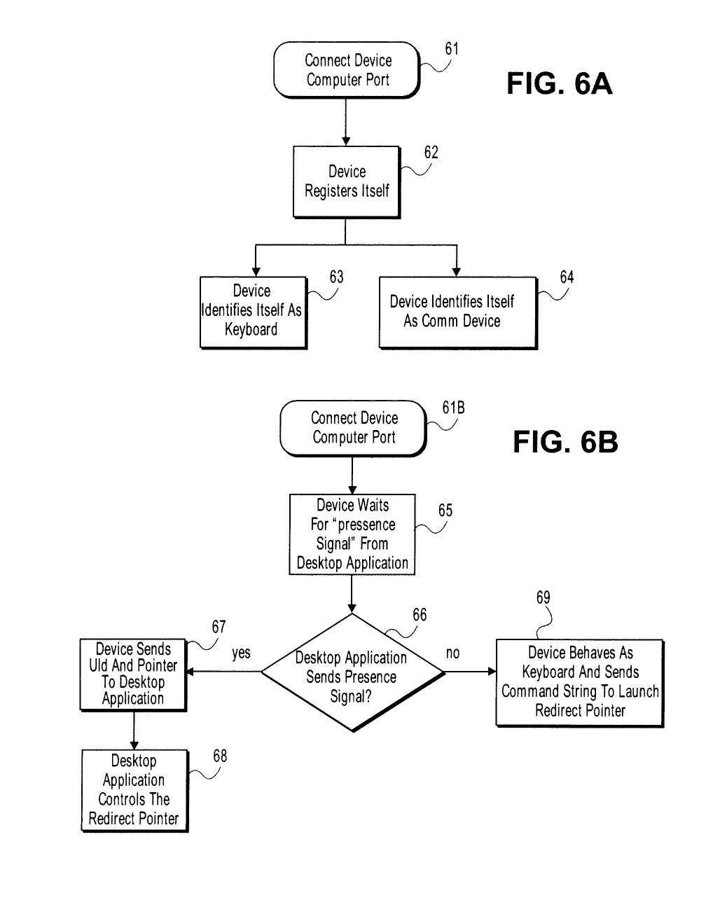

In one embodiment, When the memory device is connected to a port of a computing device, it goes through a hand shake protocol. FIGS. 6A and 6B depict two simplified hand handshake protocols between the memory device and the computer to modify or launch content, according to some embodiments of the present invention. Referring to FIG. 6A, when the memory device is connected to a port of the computer (61), the device registers itself (62), identifies itself as a keyboard (63) or as a communication (COMM) device. For example, an application software may be downloaded or a specific re-direct pointer stored in the device may be auto-launched.

Referring now to FIG. 6B, when the memory device is connected to a port of the computer (613), the device waits for a presence signal from the computer (65) and if it receives the signal, the device then sends the UID and the pointer(s) to the computer (desktop application) (67). The desktop application then controls the redirect pointer, as shown in block 68. If the memory device does not receive the presence signal from the computer, it behaves as a keyboard and sends a command string to the computer to launch an application, e.g., browser, as shown in block 69. The presence signal may be queried from a server, a local computer, or the memory device itself.

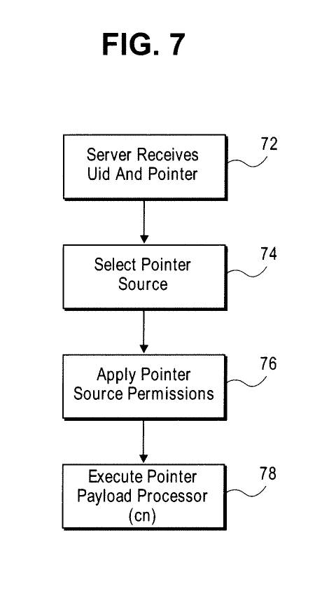

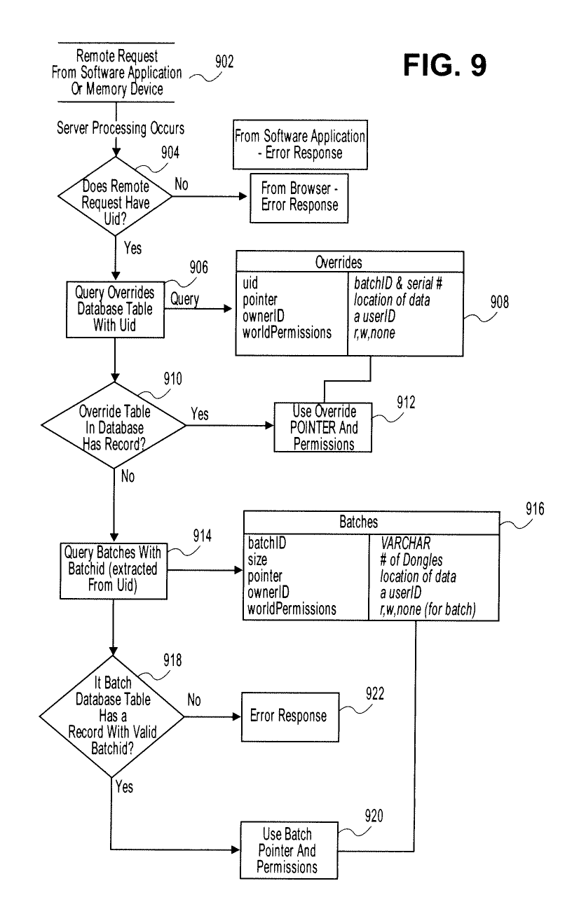

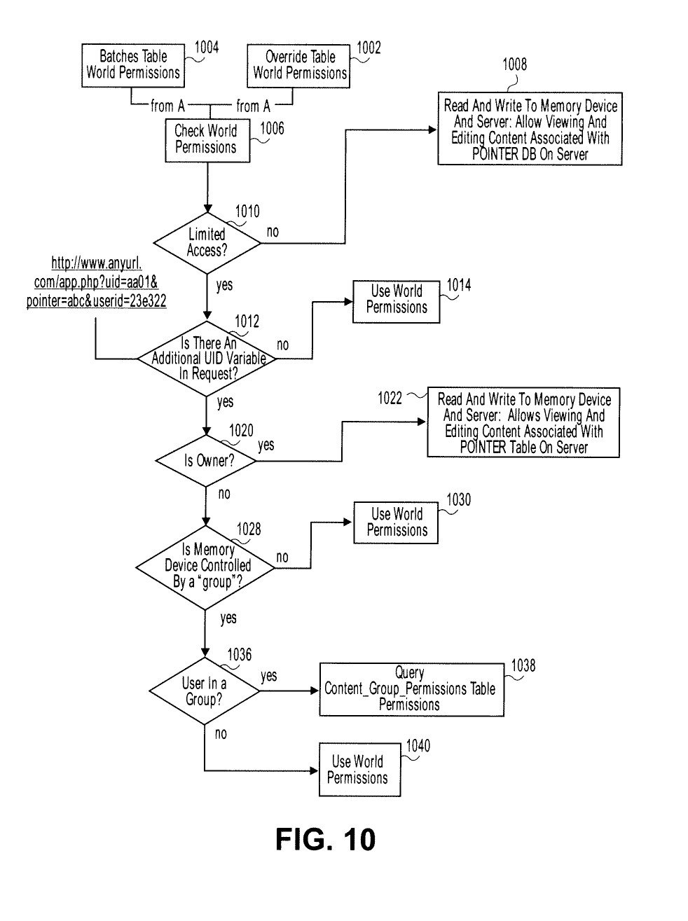

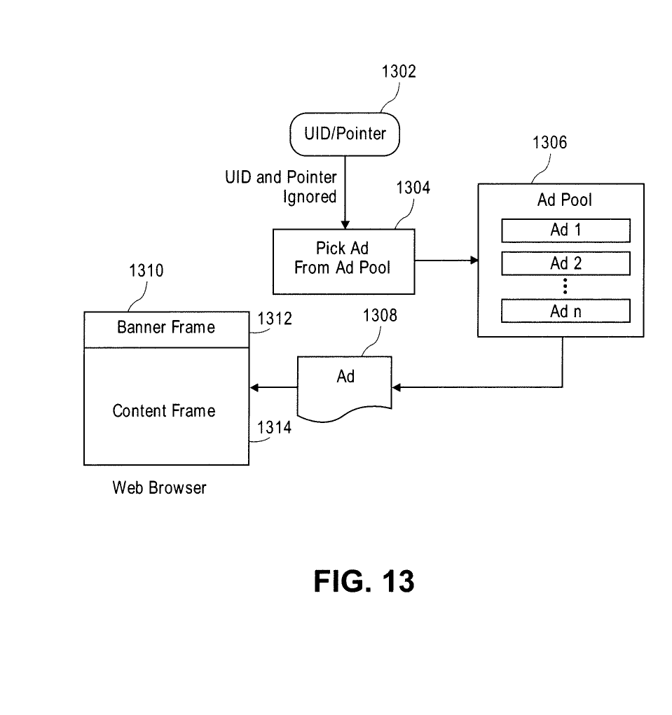

FIG. 7 is an exemplary process flow diagram showing a basic server process for receiving and executing a pointer, according to one embodiment of the present invention. In block 72, the server receives the UID and the pointer from the themed memory device. The server then selects the pointer source from pointer database in block 74. A more detailed exemplary process for selecting a pointer source is illustrated in FIG. 9. The server then applies pointer source permissions from the pointer database, if applicable, as shown in block 76. A more detailed exemplary process for applying pointer source permissions is shown in FIG. 10, according to one embodiment of the present invention. In block 78, the server then executes a pointer payload process to execute a pointer, for example, launch an application, a game, visit a website, play a song, and the like. A more detailed exemplary process for executing a pointer payload process is shown in FIG. 13, according to one embodiment of the present invention.

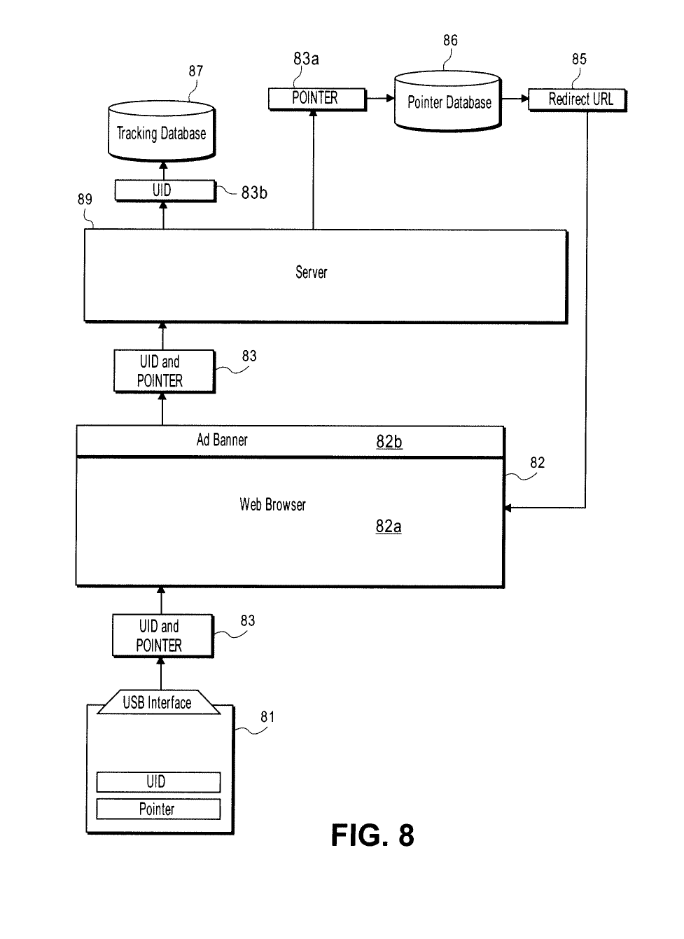

FIG. 8 is an exemplary block diagram depicting the retrieval of a content pointed to by the pointer embedded in the themed device, according to one embodiment of the present invention. First, the user connects the themed memory device 81 to, for example, a PC 82 including a web browser 82a. In response, the PC launches a web browser program and instructs the web browser to connect to a predetermined server 84 (for example, Myclickable.com™ server). The server obtains the UID(s) and the pointer(s) 83 from the memory device and retrieves a (redirect) URL 85 from the pointer database 86, according to the obtained UID(s) and the pointer(s). The server also extracts any tags that may be embedded with the pointer 83a. Utilizing the URL and the tags (if any), the server then returns the redirect pointer 85. A Tracking (statistics) database 87 pointed to the UID 83b stores all the relevant information for the users and the content and/or an ad (if one is displayed) usages.

In one embodiment, the web based content is displayed with for example, a horizontal banner 82b in a locked web frame at the top of the browser window. The source and tracking of web banner content can be associated with batches of UIDs (explained below) and/or single UIDs. The type and format of web banner content is not limited in any way and therefore can use and adhere to a variety of ad services, content and/or software applications executable via the browser.

In one embodiment, an ad is stored in a server as a text block which is inserted into the banner frame document when the banner frame is served to the user. The text block contains valid HTML or JavaScript to render the ad. Examples of ads include an ad as simple as an image reference with a link or as complex as a javascript game. The media (if any) associated with an ad can be stored on the publisher's servers, some other remote servers, or edge caching servers. The media URL(s) is included in the ads text block.

Although some exemplary embodiments of the invention disclose selecting and displaying an advertisement with a content, the present invention is not limited to selecting and displaying an advertisement. For example, another content and/or a software application may be displayed along with the first content (or the publisher's website information).

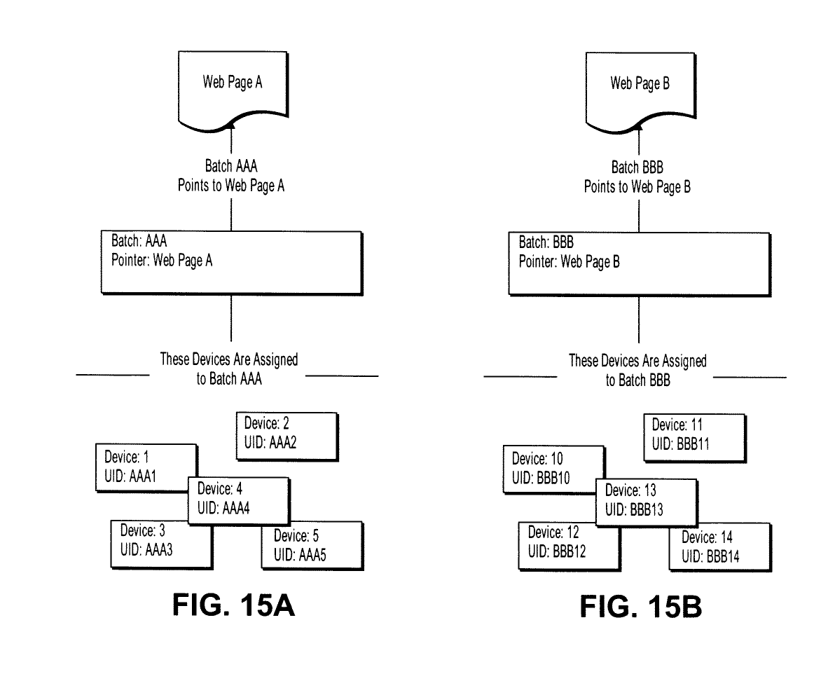

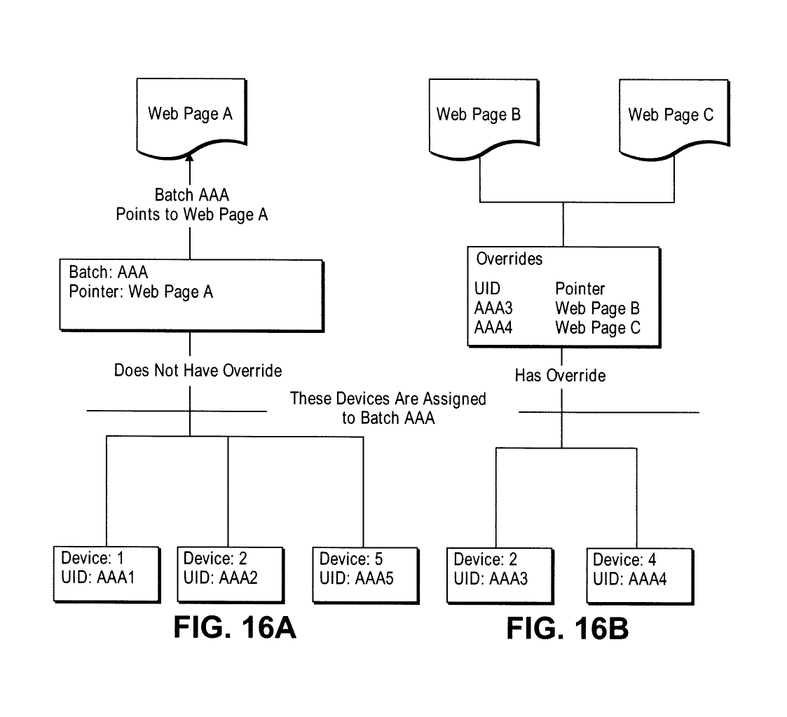

In one embodiment, each memory device may be part of a “batch” of memory devices. See FIGS. 15A, 15B, 16A and 16B in reference to the use of batches. In other words, a batch is a grouping of two or more memory devices. A batch ID, which may be a fixed string of alphanumeric characters may be embedded in a pointer. In one embodiment, the UID embedded in the memory device comprises a batch ID and a serial number (code). For example, aaaa1, aaaa2, and aaaa3 are respectively UIDs 1, 2, and 3 from the batch “aaaa.”

For instance, batches may be groups of memory devices assigned to a particular affiliate, vendor, and/or user. Every batch of memory devices has a Pointer and use permissions, which are used to determine what the memory devices in a batch will display or do, and who can see, use, or modify them. All memory devices have a UID which includes information about the batch to which they belong. When a user uses a memory device, the batch information is extracted and used to retrieve that batch's Pointer. The Pointer points to the content and/or behavior the user will receive.

For example, McDonalds™ may buy a lot of 10,000 memory devices. Each device in that lot will be assigned to the same batch by having the batch's ID written into its UID. McDonalds™ can then configure the batch Pointer to point to URL on their website. When a user uses one of those memory devices, the batch information in that memory device's UID is used to retrieve the batch Pointer which points to a particular page on the McDonalds' website.

In one embodiment, different memory devices in a given batch can point to different content and/or behavior. This is accomplished with an “override” operation. An override is the assignment of an alternate Pointer to one or more memory devices in a Batch.

In one embodiment, an “override” permission allows for specific treatment of a subset of a batch. For example, if there are 10 unique memory devices in Batch AAA, a content creator may change 5 unique batch out of Batch AAA. The override permission allows for unique behavior of these 5 specific memory devices in Batch AAA. For instance, 50,000 memory devices can be sold to a large retail company X, that is, Batch AAA includes 50,000 units. Company X then sells five of the units to a consumer and the consumer desires to modify his memory devices to launch his MySpace™ webpage on the browser. The consumer then uses a software, according to the present invention to modify the already embedded Company X pointer to his MySpace™ webpage through the override permission. In this case, the publisher's website can provide tracking data for both the batch owner (the consumer) and the override owner (Company X).

In one example, consumers purchase the themed memory devices from a website or from a retail store. A user accesses the publisher's website (for example, myclickable.com™ and creates a pointer for the device to point the memory device to a favorite website or specific web page the user selects. When the user plugs in the memory device with the embedded pointer activated, the pre-selected web page appears. In one embodiment, the pre-selected web page includes a banner ad served by a publisher's server.

In another example, Nike™ may purchase several soccer-themed memory devices. Each Nike™ memory device is pre-set to take the user to a Nike™ soccer site with a special Nike™ soccer ad banner displayed on the users screen. The Nike™ memory devices may be given away for free at Nike™ stores with a purchase. The user can set a new favorite web page by re-programming the embedded pointer in the device and give it to a friend. The new favorite web page is still framed with the Nike™ banner ad when the user inserts the soccer-themed memory device into a computer port. The displayed banner ad disappears when the user accesses another web page with the browser.

FIG. 9 illustrates an exemplary process flow for retrieving a pointer, according to one embodiment of the present invention. When a remote request from a software application or a memory device is received by the server (902), the server checks to see if the request includes a UID (904). If the request includes a UID (906), the server checks an override database (table) 908 to see whether there is an override record in the database for this UID (910). If there is an override record in the database for this UID, the server retrieves the override record and associates the relevant override rights to the memory device and generates a pointer based on the override pointer and the corresponding permissions in the override database and use that pointer and the associated permissions (912).

If there is no override record in the database, the server checks (914) a batch database (table) 916 to see if there is a batch record in the batch database 918. If there is a batch record in the batch database, the server uses the batch pointer and the corresponding permissions to generate the pointer, as shown in block 920, if not, an error message is sent (922).

In one embodiment, the method and system of the present invention includes groups. Groups are a way for user's to control who can see/use/modify their memory devices. Users can belong to multiple groups and can create groups for their own memory devices. For example, let's assume Toy Co. buys 10,000 memory devices which point to a promotion page. Toy Co. then creates a “members only” group which users can join by visiting the promotion page. Users who have not joined the group will see the promotion page. Users who have joined the group will be redirected to the another web page. In another example, a user creates a slide show, which she wants to share only with a select group of friends. The user thus creates the group and adds the select group of friends to her group. She then passes out the memory devices and only users who have been added to her group will be able to view the slide show.

FIG. 10 is an exemplary process flow for pointer permissions, according to one embodiment of the present invention. The server checks (1006) the type of permission from the batch table (1004) and/or override table (1002). If there is no limitation on the access rights, the server provides viewing and editing rights to the pointer(s) in the pointer database (1008). If there is a limited access right, the server checks to see if there is an additional UID variable in the request (1012). If there is no additional UID variable, the server checks the batch table and override table using the limited access permissions (1014).

If there is an additional UID variable in the request, the server determines if the additional UID belongs to an owner (1020). If it does, the server provides viewing and editing rights to the pointer(s) in the pointer database (1022). If there is no additional UID variable in the request, the server checks to see if the memory device is controlled by a group (1028). If the memory device is not controlled by a group, the server checks the batch table and override table using the limited access permissions (1030). If the memory device is controlled by a group, the server checks to see if the user is in that group (1036). If the user is in the group controlling the memory device, the server queries a Group Permission table (1038) to determine permission rights. If the user of the memory device is not in the group controlling the memory device, the server checks the batch table and override table using the limited access permissions (1040).

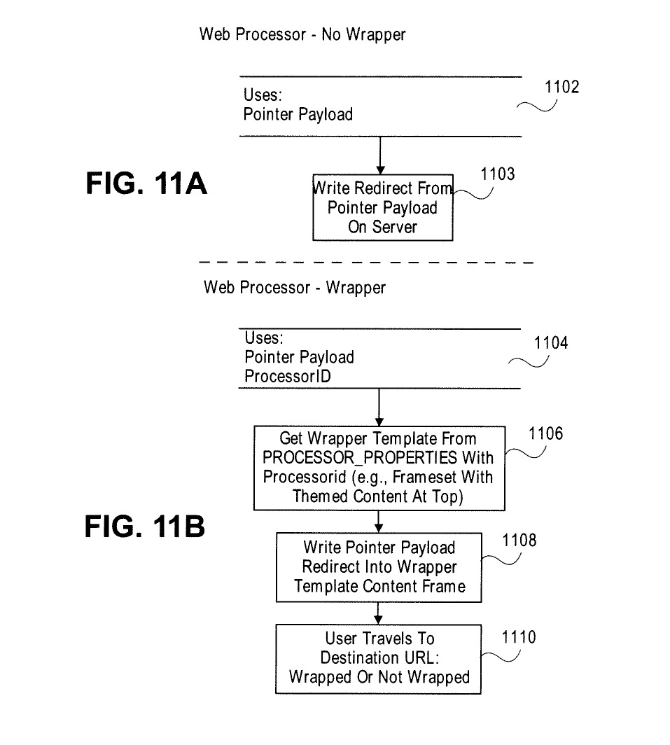

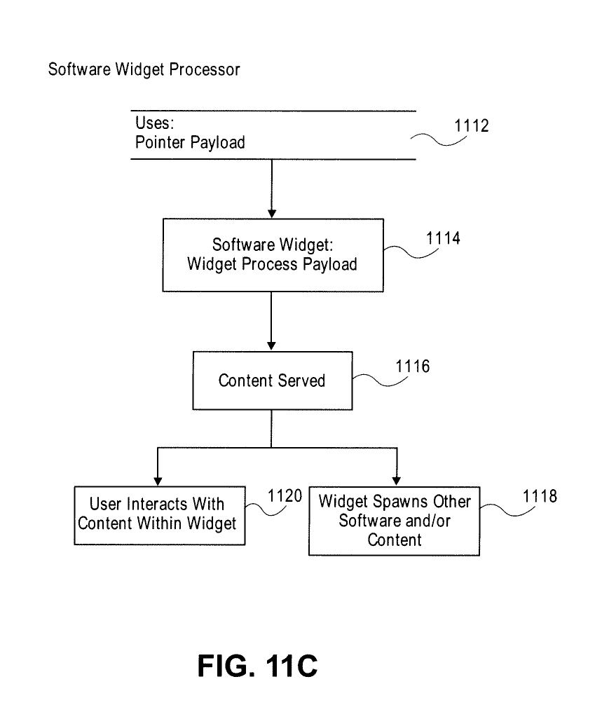

FIGS. 11A, 11B, and 11C are exemplary process flows for executing the pointer payload processor, according to one embodiment of the present invention. FIG. 11A depicts an exemplary process flow when there is no content wrapper.

FIG. 11B shows an exemplary process flow when there is a content wrapper and FIG. 11C illustrates an exemplary process flow when there is a widget processor. In one embodiment, every Pointer is composed of some data, and some behavior. The simplest case is where a Pointer represents a page on a web site. The data is the URL of the page, and the behavior is the server redirection to the URL. A Processor is the behavior portion of a Pointer.

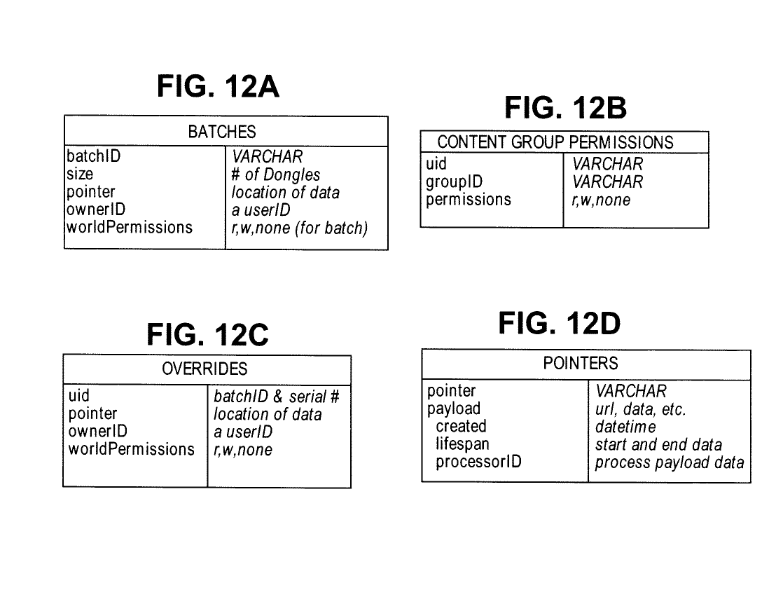

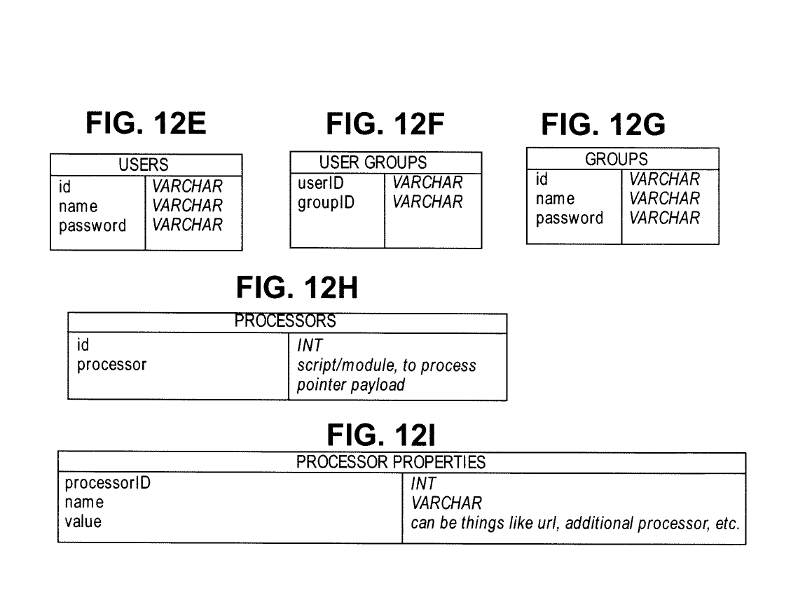

FIGS. 12A-12I show exemplary data table for batches, (12A), Group Permission (12B), Overrides (12C), Pointers (12D), Users (12E), User Groups (12F), Groups (12G), Processors (12H), and Processor Properties (12I), according to one embodiment of the present invention.

In one embodiment, the content of the ad banner comes from a rotating ad pool (for example, in the server) with no additional UID or Batch selection applied. FIG. 13 is an exemplary block diagram showing the selection of an ad, according to one embodiment of the present invention. As shown in this example, the UID(s) and the pointer(s) 1302 are ignored by the server for the purpose of selecting the ad. In this embodiment, the ad is selected (1304) from an ad pool/database 1306 based on factors other than UID and pointer. Text may be added to the selected ad (not shown) and the selected ad 1308 is then displayed in the browser 1310. In one embodiment, the displayed ad in the browser may include a banner frame 1312 and a content frame 1314. Here, the ad may be selected randomly, based on themes, for example, sports, politics, movie genres, and the like. The ad may be static or dynamic.

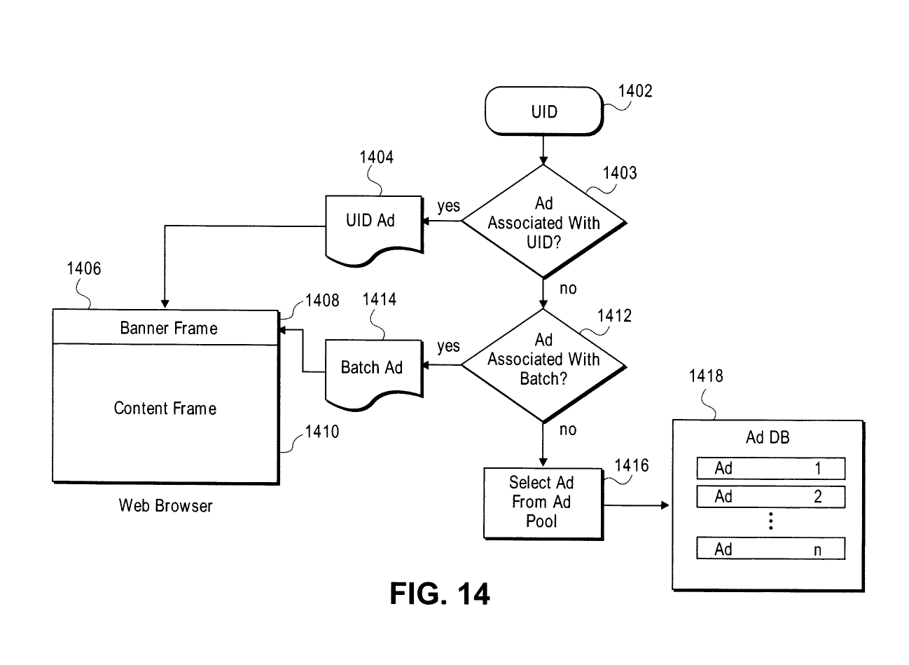

In one embodiment, the ad banner is selected based on the batch and/or the UID, as shown in FIG. 14. As shown, if the ad is associated with the UID 1402 embedded in the themed memory device (1403), an appropriate ad is selected from the ad database 1418. The selected ad 1404 is then displayed with the content in a browser 1406. For example, the ad may be related to the content addressed by the pointer or the application executed by the pointer.

If the ad is associated with a batch specified in the themed memory device (1412), an appropriate ad is selected from the ad database. The selected ad 1414 is then displayed with the content in the browser 1406, as shown in FIG. 14. For example, a batch-based ad may be a gift dongle from a retailer, such as Amazon.com™ or Target™. In this case, although the UID may be unique to each user, the entire batch of the UIDs may be related to one specific entity, company or retailer. In one embodiment, the displayed ad in the browser may include a banner frame 1408 and a content frame 1410.

In one embodiment, the ads are targeted based on the type of content a device is requesting (for example, URL of the content frame), by the type of desktop widget the device uses, or by the physical characteristics of the device itself. In one embodiment, an ad includes an “ad text block” and the ad targeting does not apply if the UID or Batch has an ad text blocked associated with it.

In one embodiment, a second content and/or a software application is displayed instead of or in addition to the ad.

In one embodiment, the server tracks different metric such as Number of themed memory devices in circulation by device, widget, and content; number of unique users of device, widget, and content; and standard web usage metrics such as visitors, unique visitors, and views.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims.

What is claimed is:

1. A method for accessing and displaying information, the method comprising:
receiving from a memory device a unique identifier and a pointer;
accessing a redirect pointer from a pointer table responsive to the unique identifier and pointer;
using the redirect pointer to launch a software application to display content;
selecting an advertisement from an ad database responsive to the unique identifier; and
displaying the advertisement with the content.

2. The method of claim 1, further comprising authenticating the unique identifier.

3. The method of claim 1, further comprising storing preferences for the memory device and accessing the redirect pointer responsive to the preferences.

4. The method of claim 1, further comprising assigning the memory device to a predetermined batch of memory devices and associating one or more pointers to the batch of memory devices.

5. The method of claim 1, further comprising assigning an alternative pointer to the memory device.

6. The method of claim 1, wherein selecting the advertisement comprises selecting the advertisement randomly from the ad database.

7. The method of claim 1, wherein selecting the advertisement comprises selecting the advertisement according to a predetermined criterion from the ad database.

8. The method of claim 1, further comprising coupling the memory device to any one of a PC, PDA, cell phone, iPOD™, game console, or Pocket PC.

9. The method of claim 1, wherein the memory device has, or is embedded in an object having a themed appearance having relevance to the first content.

10. The method of claim 1, wherein the memory device includes one or more switches for selecting one or more unique identifiers.

11. The method of claim 1, wherein the memory device includes one or more switches for selecting one or more pointers.

12. The method of claim 1, wherein launching a software application comprises one or more of launching a second application, launching a game, visiting a website, or playing a song.

13. The method of claim 1, wherein retrieving and using the redirect pointer comprises:
selecting a redirect pointer from a pointer database;
applying pointer permissions from the pointer database; and
executing a pointer payload process to launch the software application.

14. The method of claim 13, further comprising:
checking for a batch ID in a batch table; and
checking for an alternative pointer in an override table.

15. The method of claim 1, wherein the redirect pointer is stored in a user profile.

16. The method of claim 15, further comprising editing the user profile.

17. A method for accessing and displaying information, the method comprising:
receiving from a memory device a unique identifier and a pointer;
accessing a redirect pointer from a pointer table responsive to the unique identifier and pointer;
using the redirect pointer to launch a software application to display a first content; and
displaying a second content with the first content responsive to the unique identifier.

18. The method of claim 17, further comprising storing preferences for the memory device and using the redirect pointer responsive to the preferences.

19. The method of claim 17, further comprising assigning the memory device to a predetermined batch of memory devices and associating one or more pointers to the batch of memory devices.

20. The method of claim 17, further comprising assigning an alternative pointer to the memory device.

21. The method of claim 17, wherein the second content is an advertisement.

22. The method of claim 17, further comprising coupling the memory device to any one of a PC, PDA, cell phone, iPOD™, game console, or Pocket PC.

23. The method of claim 17, wherein the memory device has, or is embedded in an object having a themed appearance having relevance to the first content.

24. The method of claim 17, wherein the memory device includes one or more switches for selecting one or more unique identifiers.

25. A system for accessing and displaying information comprising:
means for retrieving from a memory device a unique identifier and a pointer;
means for retrieving a redirect pointer from a pointer table responsive to the unique identifier and pointer;
means for executing the redirect pointer to launch a software application to display a first content; and
means for displaying a second content with the first content responsive to the unique identifier.

26. The system of claim 25, wherein the second content is an advertisement.

27. The system of claim 25, wherein the memory device is embedded in an object having a themed appearance with relevance to the first content.

28. The system of claim 25, wherein the memory device includes as least two connection ports for chaining the memory device to a second memory device and uploading the unique identifier to the second memory device.
